(19) United States
(12) Patent Application Publication
(10) Pub. No.: US 2013/0250200 A1
(43) Pub. Date: Sep. 26, 2013

(54) ARRAY SUBSTRATE FOR LIQUID CRYSTAL DISPLAY PANEL

(71) Applicant: Ryoh Ohue, Osaka (JP)

(72) Inventor: Ryoh Ohue, Osaka (JP)

(73) Assignee: SHARP KABUSHIKI KAISHA, Osaka (JP)

(21) Appl. No.: 13/991,808

(22) PCT Filed: Dec. 2, 2011
(86) PCT No.: PCT/JP2011/077888

§ 371 Date: Jun. 5, 2013

(30) Foreign Application Priority Data
Dec. 10, 2010 (JP) 2010-276026

(51) Int. Cl. G02F 1/1362

(52) U.S. Cl. CPC G02F 1/136277
USPC 349/42

(57) ABSTRACT

An array substrate 20 is provided with a main array substrate body 21, and wiring lines 51 (42) including thin film transistors 50 formed on one panel surface 22 of the main array substrate body. In the surface 23 of the main array substrate body on the side opposite to the panel surface 22 having the wiring lines formed thereon, a plurality of concavities 25 recessed from the surface of the main array substrate body are formed.

### TECHNICAL FIELD

The present invention relates to an array substrate for a liquid crystal display panel used to manufacture a liquid crystal display panel.

This application claims the benefit of Japanese Patent Application No. 2010-276026, filed in Japan on Dec. 10, 2010, which is hereby incorporated by reference in its entirety.

### BACKGROUND ART

Liquid crystal display devices that include a liquid crystal display panel are widely used as an image display device (display) for televisions, personal computers, and the like. Such a liquid crystal display panel includes a pair of glass substrates (an array substrate and a color filter (CF) substrate) with a liquid crystal layer interposed therebetween, and image display is conducted by selectively applying a voltage between the array substrate and the CF substrate for each pixel, and thereby controlling the liquid crystal molecules in the liquid crystal layer. Here, an active matrix liquid crystal display panel includes, on the array substrate, a plurality of gate wiring lines (scanning wiring lines) and source wiring lines (signal wiring lines) intersecting orthogonally with each other, and pixels that include thin film transistors (TFTs) as switching elements at respective intersection points between the gate wiring lines and the source wiring lines, for example.

In a step of assembling the liquid crystal display panel, the array substrate on which TFTs are formed (TFT array substrate) is placed on a prescribed device stage and undergoes a prescribed process. After placing the array substrate on an exposure stage, exposure is conducted, and then after this step, the array substrate is transferred to the next step, for example. At this time, the roughness of the rear of the array substrate made of a glass substrate is small, and thus, there are cases in which static electricity (peeling electrification) occurs in the array substrate when lifting the array substrate from the device stage and transferring the array substrate to the next step. As a result, there is a risk that defects such as ESD (electrostatic discharge) occur in the TFTs formed on the array substrate as a result of accumulated static electricity, which results in a decrease in manufacturing yield. Patent Document 1 is an example of related art that discloses a technique to handle this problem. Patent Document 1 discloses a liquid crystal display panel that includes a protective circuit to prevent defects resulting from static electricity.

### RELATED ART DOCUMENT

### Patent Document

Patent Document 1: Japanese Patent Application Laid-Open Publication No. 2005-275004

### SUMMARY OF THE INVENTION

### Problems to be Solved by the Invention

However, an object of the conventional technique such as that mentioned above is to protect the TFT substrate formed on the array substrate from static electricity when static electricity occurs in the array substrate itself, and is not to prevent the occurrence of static electricity in the array substrate.

The present invention was made in order to solve the above-mentioned problem of conventional devices, and an object thereof is to provide an array substrate for a liquid crystal panel with a structure that can prevent the occurrence of defects resulting from static electricity by minimizing the occurrence of static electricity, which can occur in the array substrate itself when manufacturing the liquid crystal display panel. Another object thereof is to provide a liquid crystal panel that includes the array substrate for a liquid crystal panel, and a liquid crystal display device that includes the liquid crystal panel.

### Means for Solving the Problems

In order to attain the above-mentioned objects, the present invention provides an array substrate for a liquid crystal display panel of a configuration below. That is, an array substrate of the present invention includes: a main array substrate body; and wiring lines including thin film transistors disposed on one panel surface of the main array substrate body. In the main array substrate body, a surface thereof has a plurality of concavities that are recessed from the surface of the main array substrate body, the surface being on a side opposite to the panel surface where the wiring lines are disposed.

An array substrate for a liquid crystal display panel provided in the present invention includes a plurality of concavities artificially formed in the panel surface of the main array substrate body (typically a glass substrate) on the side opposite to the surface where wiring lines including thin film transistors (TFTs) are formed.

According to this configuration, a plurality of concavities are formed (typically formed regularly in a prescribed pattern) in a surface on the side opposite to the surface where the wiring lines of the main array substrate body are formed (rear surface of the main array substrate body), thereby increasing the roughness (surface roughness) of the rear surface of the main array substrate body. Thus, when the array substrate that includes the main array substrate body in which the concavities are formed is lifted and transferred from a prescribed stage after the array substrate is directly mounted on the stage and a prescribed treatment is conducted, it is possible to prevent the occurrence of defects due to static electricity by mitigating peeling electrification between the stage and the array substrate.

In one preferred embodiment of the array substrate disclosed herein, the plurality of concavities are disposed in positions corresponding to the thin film transistors (TFTs).

According to this configuration, the respective concavities are formed on the rear side of the main array substrate body in positions corresponding to where the TFTs are formed (in other words below where the TFTs are formed), and thus, it is possible to prevent the occurrence of peeling electrification where the TFTs are formed.

In another preferred embodiment of the array substrate disclosed herein, the wiring lines include a plurality of gate wiring lines and a plurality of source wiring lines intersecting with the gate wiring lines. The plurality of concavities are disposed regularly along the gate wiring lines and the source wiring lines, in positions corresponding to the gate wiring lines and the source wiring lines.

According to this configuration, the respective concavities are formed regularly (continuously or intermittently, for example) in the rear surface of the main array substrate body in positions corresponding to where the source wiring lines and the gate wiring lines are formed (in other words, positions corresponding to where the black matrix is formed on the color filter substrate), and thus, it is possible to more effectively mitigate the occurrence of peeling electrification in the array substrate by further increasing the roughness of the rear surface of the main array substrate body. Because the concavities are formed below the gate wiring lines and the source wiring lines, it is possible to mitigate defects (display unevenness and the like, for example) in image display occurring due to changes in optical characteristics that could occur due to the formation of the concavities.

In another preferred embodiment of the array substrate disclosed herein, the plurality of concavities are filled with an anti-static substance.

According to this configuration, the occurrence of static electricity in the array substrate can be more effectively prevented.

According to the present invention, a liquid crystal display panel including any one of the array substrates for a liquid crystal panel disclosed herein is provided. The liquid crystal display panel includes the array substrate and thus, a high quality array substrate that can mitigate the occurrence of defects in the TFTs can be attained. Also, according to the present invention, a liquid crystal display device including such a liquid crystal display panel is provided.

### BRIEF DESCRIPTION OF THE DRAWINGS

FIG. 1 is an exploded perspective view that schematically shows a structure of a liquid crystal display device of one embodiment of the present invention.

FIG. 2 is a partial cross-sectional view that schematically shows the structure of the liquid crystal display panel of one embodiment of the present invention.

FIG. 3 is a partial plan view that shows pixel areas of an array substrate of the liquid crystal display panel of one embodiment of the present invention.

FIG. 4 is a cross-sectional view along the line IV-IV in FIG. 3 that shows the structure of the array substrate.

FIG. 5A is a schematic cross-sectional view that shows a state in which a resist film is formed in prescribed positions on a main array substrate body, which is a constituent of the array substrate according to one embodiment of the present invention.

FIG. 5B is a schematic cross-sectional view that shows a state in which the main array substrate body is patterned after etching.

FIG. 5C is a cross-sectional view that schematically shows the main array substrate body after the resist film is removed.

FIG. 5D is a schematic cross-sectional view that shows a structure of the array substrate according to one embodiment of the present invention.

FIG. 6 is a cross-sectional view that shows a structure of the array substrate according to another embodiment of the present invention.

FIG. 7 is a cross-sectional view that shows a structure of the array substrate according to another embodiment of the present invention.

### DETAILED DESCRIPTION OF EMBODIMENTS

Below, preferred embodiments of the present invention will be explained with reference to figures. Matters not specifically mentioned herein, but necessary to implement the present invention can be worked out as design matters by those skilled in the art based on conventional technologies in the field. The present invention can be implemented based on the contents disclosed herein and common technical knowledge in the field.

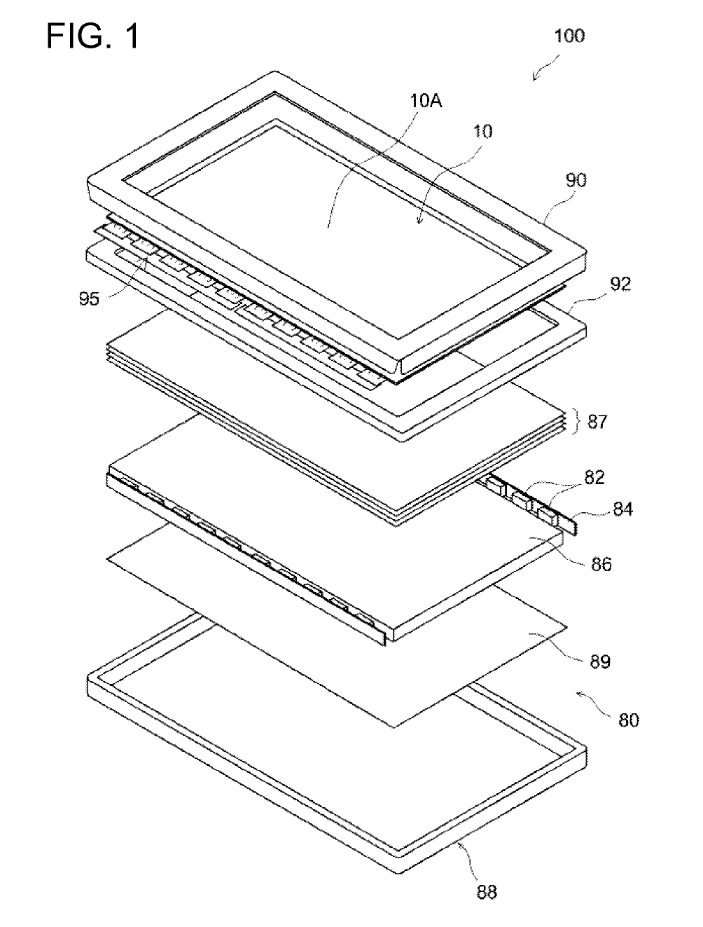

With reference to FIGS. 1 to 4, a liquid crystal display panel 10 that includes an array substrate 20 for a liquid crystal display panel according to a preferred embodiment (Embodiment 1) of the present invention, and an active matrix (TFT-type) liquid crystal display device 100 that includes the liquid crystal display panel 10 will be described below.

In the following figures, the same reference characters are given to members and portions that have the same functions, and duplicative explanations may be omitted or abridged. Also, the dimensional relationship (length, width, thickness, and the like) in each of the figures does not necessarily reflect the actual dimensional relationship accurately. In the description below, “front surface” or “front side” refers to a side facing a viewer of the liquid crystal display device 100 (that is, the side of the liquid crystal display panel 10), and “rear surface” or “rear side” refers to a side not facing the viewer of the liquid crystal display device 100 (that is, the side of a backlight device 80).

First, an overall configuration of the liquid crystal display device 100 will be explained. As shown in FIG. 1, the liquid crystal display device 100 includes a liquid crystal display panel 10 and a backlight device 80 that is an external light source disposed on the rear surface side of the liquid crystal display panel 10. The liquid crystal display panel 10 and the backlight device 80 are assembled by a bezel (frame member) 90 or the like, thereby being held as one component.

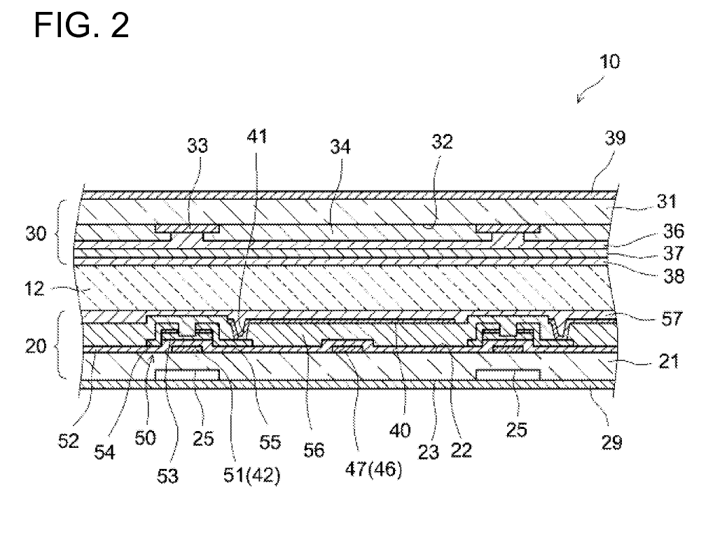

As shown in FIG. 1, the liquid crystal display panel 10 typically has a rectangular shape as a whole, and has a display region 10A in the central portion thereof. The display region 10A has pixels formed therein, and displays images. Also, as shown in FIG. 2, the liquid crystal display panel 10 has a sandwiched structure including a pair of transparent glass substrates 20 and 30 that face each other, and a liquid crystal layer 12 sealed therebetween. Of the pair of substrates 20 and 30, one on the front side is a color filter substrate (CF substrate) 30, and the other on the rear side is an array substrate (TFT array substrate) 20. In the periphery of the CF substrate 30 and the array substrate 20, a sealing member (not shown in drawings) is provided so as to enclose the display region, thereby sealing in the liquid crystal layer 12. The liquid crystal layer 12 is made of a liquid crystal material that includes liquid crystal molecules. The orientation of the liquid crystal molecules is controlled by an electric field applied between the array substrate 20 and the CF substrate 30, which changes the optical characteristics of the liquid crystal material.

In the gap between the array substrate 20 and the CF substrate 30 a plurality of spacers (not shown in drawings), which are formed in a spherical or cylindrical shape of an elastically deformable resin material, are dispersed between the array substrate 20 and the CF substrate 30. As a result of the spacers, the gap between the substrates 20 and 30 is maintained by the above-mentioned sealing member and the spacers, which maintains the liquid crystal layer 12 at an even thickness.

Also, polarizing plates 29 and 39 are respectively bonded to the surfaces of the respective substrates 20 and 30 that do not face each other (outer surfaces).

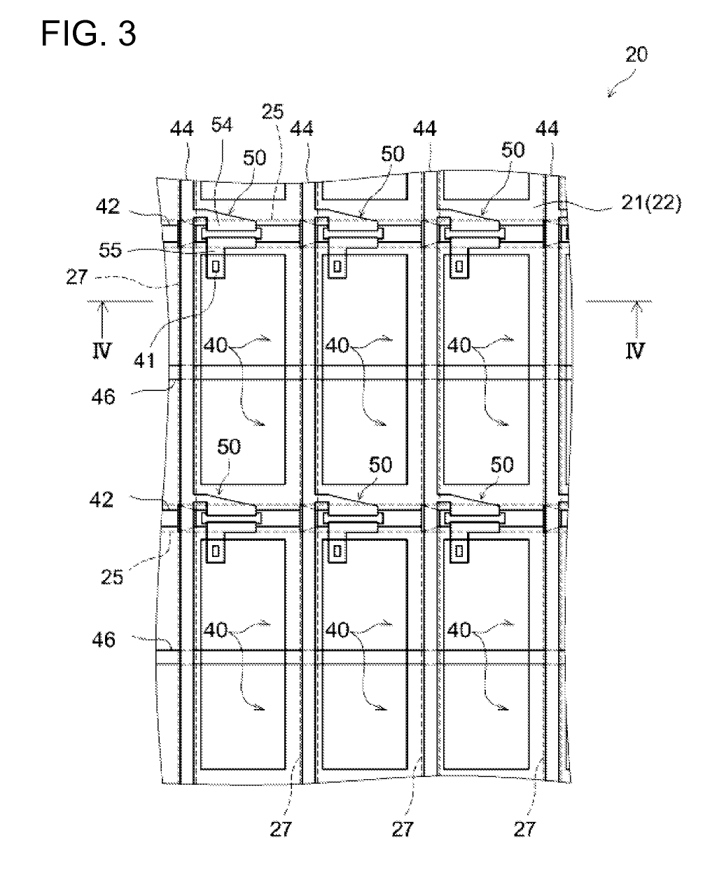

As shown in FIG. 3, in the liquid crystal display panel 10 disclosed herein, pixels for display (pixel electrodes 40) are arranged on a panel surface (on the side of the liquid crystal layer 12) 22 on the front side of a main array substrate body 21 made of glass and constituting the array substrate 20, and gate wiring lines (scanning wiring lines) 42 and source wiring lines (signal wiring lines) 44, which are a plurality of wiring lines for driving the respective pixels, are formed in a grid pattern. On the panel surface 22 on the front side of the main array substrate body 21, auxiliary capacitance wiring lines (also referred to as storage capacitance wiring lines or Cs lines) 46, which are wiring lines portions independently provided parallel to the gate wiring lines 42, are provided separately.

Each grid region surrounded by the gate wiring lines 42 and the source wiring lines 44 has a pixel electrode 40 and a thin film transistor (also referred to simply as “TFT” below) 50, which is a switching element, formed therein.

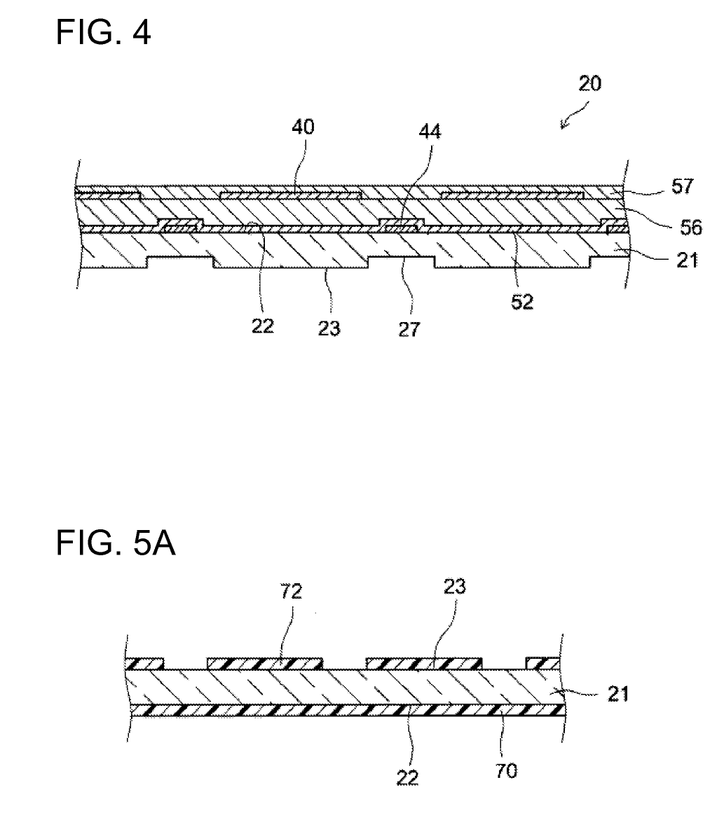

As shown in FIG. 2, a surface 23 on a side opposite to the panel surface 22 on the front side of the main array substrate body 21 where the TFTs 50 are formed (in other words, the rear surface of the main array substrate body 21, also referred to simply as the “rear panel surface 23”) has a plurality of concavities 25, which are recessed from the panel surface 23 on the rear side of the main array substrate body 21 and artificially formed therein. The concavities 25 of the present embodiment are formed such that the horizontal cross-sectional view thereof shown in FIG. 2 is rectangular. The concavities 25 can be formed in any position without limit as long as they are formed in the panel surface 23 on the rear side of the main array substrate body 21, but it is preferable that the concavities 25 be formed in positions other than those corresponding to where the pixel electrodes 40 are formed (that is, below the pixel electrodes 40) such as in positions corresponding to where the black matrix 33 is formed on the color filter substrate 30, for example. As shown in FIG. 2, the concavities 25 of the present embodiment are formed in positions corresponding to where the TFTs 50 are formed (in other words, below the TFTs 50). Additionally, as shown in FIGS. 3 and 4, in the surface 23 on the side opposite to the panel surface 22 on the front side of the main array substrate body 21 where the gate wiring lines 42 and the source wiring lines 44 are formed, the concavities 25 and concavities 27, which are recessed from the surface of the main array substrate body 21, are formed regularly (continuously or intermittently, for example) in a prescribed pattern along the gate wiring lines 42 and the source wiring lines 44. In the present embodiment, the concavities 25 and the concavities 27 are formed continuously along the gate wiring lines 42 and the source wiring lines 44.

The shape of the concavities 25 and 27 (shape of the recessed portions) is not limited. The shape thereof is not limited to a rectangular shape in the above-mentioned horizontal cross-sectional view, and may be trapezoidal, semicircular, or the like, for example.

As shown in FIG. 3, the TFTs 50 of the present embodiment are formed over the gate wiring lines 42 (more specifically, over the gate wiring line 42 in the vicinity of the intersection point thereof with the source wiring line 44) in order to attain a large pixel aperture ratio. As shown in FIG. 2, the TFT 50 has a reverse-staggered structure with a layered structure including a gate electrode 51 formed on the surface 22 of the main array substrate body 21, a gate insulating film (insulating layer) 52 formed (layered) on the gate electrode 51, a semiconductor film (semiconductor layer) 53 formed on the gate insulating film 52, and a source electrode 54 and a drain electrode 55 formed on the semiconductor film 53. The gate electrode 51 is connected to the gate wiring line 42 (refer to FIG. 3), and the source electrode 54 is connected to the source wiring line 44 (refer to FIG. 3), both electrodes respectively included in the wiring lines.

Additionally, as shown in FIG. 2, the TFT 50 is covered by an interlayer insulating film (interlayer insulating layer) 56 made of an insulating material. The interlayer insulating film 56 has a contact hole 41 formed therein, and the drain electrode 55 of the TFT 50 is electrically connected to the pixel electrode 40 through the contact hole 41. The pixel electrode 40 is typically made of ITO (indium tin oxide), which is a transparent conductive material. An alignment film 57 made of polyimide or the like is formed covering the surface of the pixel electrode 40. The surface of the alignment film 57 (that is, the surface in contact with the liquid crystal layer 12) has alignment treatment (rubbing treatment, photoalignment treatment, or the like, for example) conducted thereon in order to set the orientation of the liquid crystal molecules when a voltage is not applied thereon. A voltage based on an image is supplied to the pixel electrodes 40 at a prescribed timing through the gate wiring lines 42, the source wiring lines 44, and the TFTs 50.

As shown in FIG. 2, each grid region has an auxiliary capacitance electrode (also referred to as a storage capacitance electrode or a Cs electrode) 47 formed therein. The auxiliary capacitance electrode 47 is electrically connected to the auxiliary capacitance wiring line 46. An auxiliary capacitance for maintaining a voltage applied to the pixel 40 is generated between a portion of the pixel electrode 40 and the auxiliary capacitance electrode 47.

As shown in FIG. 1, the gate wiring lines 42 and the source wiring lines 44 are typically connected to an external driver circuit 95 including a driver IC provided in the periphery of the liquid crystal display panel 10, the external driver circuit 95 being able to supply image signals and the like.

On the other hand, as shown in FIG. 2, in the display region 10A, one color filter 34 out of the subpixel colors of R (red), G (green), B (blue), and Y (yellow) is formed in each position opposite to the pixel area (pixel electrode 40) of the array substrate 20 on the panel surface (facing the liquid crystal layer 12) 32 on the front side of the main substrate body (glass substrate) 31 of the CF substrate 30. The black matrix (light-shielding film) 33 for preventing light leakage between subpixels, increasing contrast, and preventing the respective colors from mixing is formed dividing the color filters 34. The black matrix 33 and the color filters 34 are covered by an insulating film (planarizing film) 36 made of an insulating resin material, for example, and an opposite electrode (common electrode) 37 made of ITO is formed on the surface of the insulating film 36. An alignment film 38 is formed on the surface (liquid crystal layer 12 side) of the opposite electrode 37. The surface of the alignment film 38 is also given an alignment treatment similar to that of the alignment film 57.

As shown in FIG. 1, a bezel 90 is mounted on the front of the liquid crystal display panel 10. A frame 92 is mounted on the rear side of the liquid crystal display panel 10. The bezel 90 and the frame 92 are fixed to each other with the liquid crystal display panel 10 therebetween. Furthermore, the frame 92 has an opening corresponding to the display region 10A in the central portion of the liquid crystal display panel 10. A backlight device 80 is mounted on the rear (rear of the bezel 90) of the liquid crystal display panel 10.

As shown in FIG. 1, the backlight device 80 includes a plurality of point light sources (typically LEDs) 82, a light guide plate 86 that converts light from the light sources 82 into planar light, and a chassis 88 that stores these, for example. The light sources 82 are disposed on wiring line substrates 84, and are covered by a reflector (reflective film) that is not shown in the drawings in order to efficiently radiate light from the light sources 82 to the light guide plate 86. The chassis 88 has a box shape with an opening facing the front, and a reflective sheet 89 for efficiently reflecting light from the light sources 82 towards the viewer is disposed between the light guide plate 86 and the chassis 88.

A plurality of sheet-shaped optical sheets 87 are layered covering the front of the light guide plate 86. The optical sheets 78 are constituted of a diffusion plate, a diffusion sheet, a lens sheet, and a brightness enhancement sheet in this order from the backlight device 80 side, for example, but are not limited to this combination and order. The optical sheets 87 are held between the chassis 88 and the frame 92. An inverter circuit substrate not shown in the drawings for mounting an inverter circuit thereon, and an inverter transformer not shown in the drawings functioning as a booster circuit that supplies power to each light source 82 are provided on the rear side of the chassis 74. However, descriptions thereof will be omitted as these are not characterizing features of the present invention.

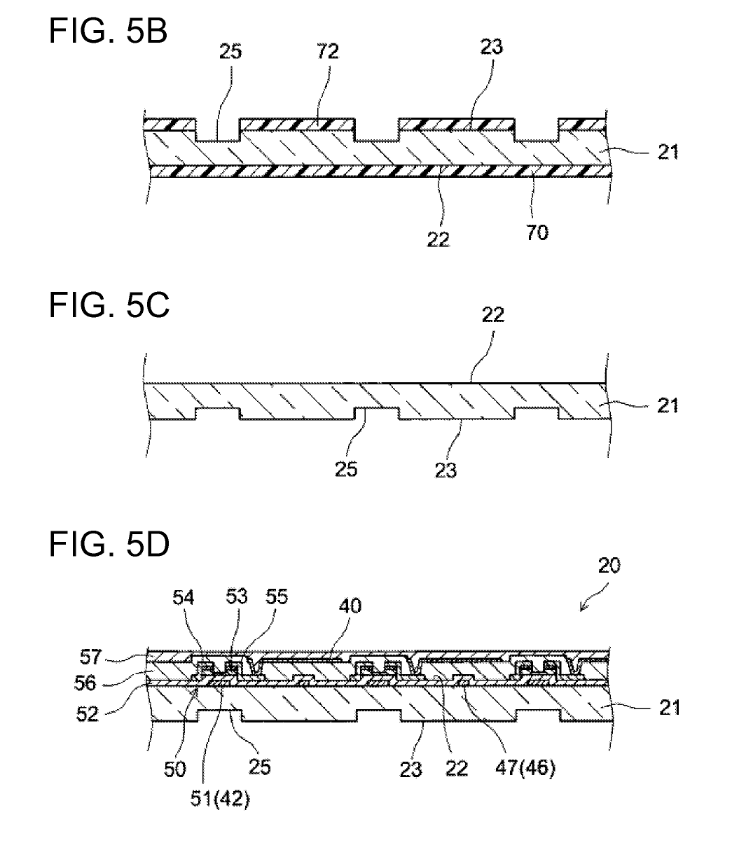

Next, with reference to FIGS. 5A to 5D, one preferred example of a manufacturing method for the array substrate 20 for the liquid crystal display panel of the present embodiment will be described.

First, the main array substrate body 21 made of glass cut out from a mother glass is prepared. A resist film 70 made of an ultraviolet-sensitive resin is coated onto the panel surface 22 on the front side of the main array substrate body 21 (step of resist coating). The resist film (a positive resist film 70, for example) is cured by prebaking (step of prebaking). Next, a resist film 72 is coated onto the panel surface 23 on the rear side of the main array substrate body 21 and cured in a similar manner. A patterned mask is placed over the cured resist film 72 and ultraviolet light of a prescribed wavelength (an i-line 365 nm in wavelength, for example) is radiated through the mask, thereby conducting exposure on the resist film 72 (step of exposure). The post-exposure main array substrate body 21 is soaked in developer and then rinsed in pure water, thereby removing through dissolution exposed portions of the resist film 72 (step of development). Then, postbaking is conducted (step of postbaking). Thus, as shown in FIG. 5A, a resist film 72 that has the pattern of the above-mentioned mask (unexposed portions of the positive resist film) is formed on the main array substrate body 21.

Next, as shown in FIG. 5B, etching is conducted, forming concavities 25 with a prescribed depth in prescribed areas where the resist film 72 is not formed on the main array substrate body 21 (step of etching). Dry etching and wet etching are examples of the etching process. Dry etching and the like using gas radicals generated by plasma can be preferably used, for example. The depth of the concavities 25 can be appropriately adjusted by the etching conditions (etching rate, for example). A depth of 400 nm to 1 μm is preferable as a depth for the concavities 25. Finally, the resist film 72 and the resist film 70 are removed from the main array substrate body 21 using oxygen gas plasma or the like, for example (step of resist removal).

As a result, as shown in FIG. 5C, a plurality of concavities 25 are formed in the panel surface 23 on the rear side of the main array substrate body 21.

Next, as shown in FIG. 5D, a multilayer conductive film including titanium (Ti) and aluminum (Al), which constitute the gate electrodes 51 (gate wiring lines 42) and the auxiliary capacitance electrodes 47 (auxiliary capacitance wiring lines 46), is deposited (vapor deposition) by sputtering onto the main array substrate body 21 (step of film-forming). Then, resist is coated onto the multilayer conductive film in a step of resist coating, and patterned in steps of prebaking, exposure, development, postbaking, etching, and resist removal, thus forming the gate electrodes 51 (gate wiring lines 42) and auxiliary capacitance electrodes 47 (auxiliary capacitance wiring lines 46) of a prescribed pattern on the main array substrate body 21.

The gate insulating film (insulating layer) 52 is formed on the gate electrodes 51 and the auxiliary capacitance electrodes 47. The gate insulating film 52 is formed of SiNₓ, SiOₓ, or the like by plasma CVD, for example. The semiconductor film (semiconductor layer) 53 is formed on the gate insulating film 52, over the gate electrode 51. The gate insulating film 52 made of SiNₓ or the like, the semiconductor film 53 with a two layer structure of an α-Si layer and an n+α-Si layer, and a channel protective film layer interposed between the two layers of the semiconductor film 53 can be layered four layers in a row by plasma CVD. Resist is coated onto the layered semiconductor film 53 by a step of resist coating, and the semiconductor film 53 is patterned by the steps of prebaking, exposure, development, postbaking, etching, and resist removal.

Next, in a manner similar to that of the gate electrode 51 (gate wiring line 42), source wiring lines 44, and a conductive film with a two-layered structure (the bottom layer being titanium, the top layer being aluminum) to become the source electrode 54 and the drain electrode 55 on the semiconductor film 53 are formed. In the step of etching, it is preferable that a portion (channel) between the source electrode 54 and the drain electrode 55 be etched until the semiconductor film 53 (technically the front layer of the channel protective film formed between the α-Si layer and the n+α-Si layer) is exposed.

The TFT 50 is formed by forming an interlayer insulating film (interlayer insulating layer) 56 made of SiNₓ by plasma CVD to cover the source electrode 54 and the drain electrode 55, which were formed in the manner described above, and the semiconductor film 53 exposed in the channel between the electrodes 54 and 55. A contact hole 41 is formed in the interlayer insulating film 56. Then, a transparent conductive film made of ITO is sputtered onto the interlayer insulating film 56 and patterned so as to function as the pixel electrode 40, thus forming a pixel area in a prescribed pattern. At this time, the pixel electrode 40 is formed so as to be electrically connected to the drain electrode 55 through the contact hole 41.

Next, an alignment film material is coated onto the interlayer insulating film 56 and the pixel electrode 40 by the inkjet method, for example, and then, alignment treatment is conducted on the alignment film material (rubbing treatment, photoalignment treatment, or the like, for example) in order to control the orientation of the liquid crystal molecules, thus forming the alignment film 57.

The array substrate 20 is manufactured by the steps above.

As shown in FIGS. 4 and 5D, in the panel surface 23 on the rear side of the main array substrate body 21 in the array substrate 20 of the present embodiment, concavities 25 that are recessed from the surface of the main array substrate body 21 are formed regularly (continuously in the present embodiment) along the gate wiring lines 42 and below the TFTs 50, and the concavities 27 are formed regularly (continuously in the present embodiment) along the source wiring lines 44. As a result, the roughness of the panel surface 23 on the rear side of the main array substrate body 21 increases. Thus, it is possible to effectively prevent the occurrence of peeling electrification between the stage and the array substrate 20 when the array substrate 20 of the present embodiment is lifted from the stage and transported after conducting prescribed processes in the manufacturing steps for the liquid crystal display panel, and thus, it is possible to prevent defects resulting from peeling electrification (static electricity) in the TFTs 50 formed in the array substrate 20.

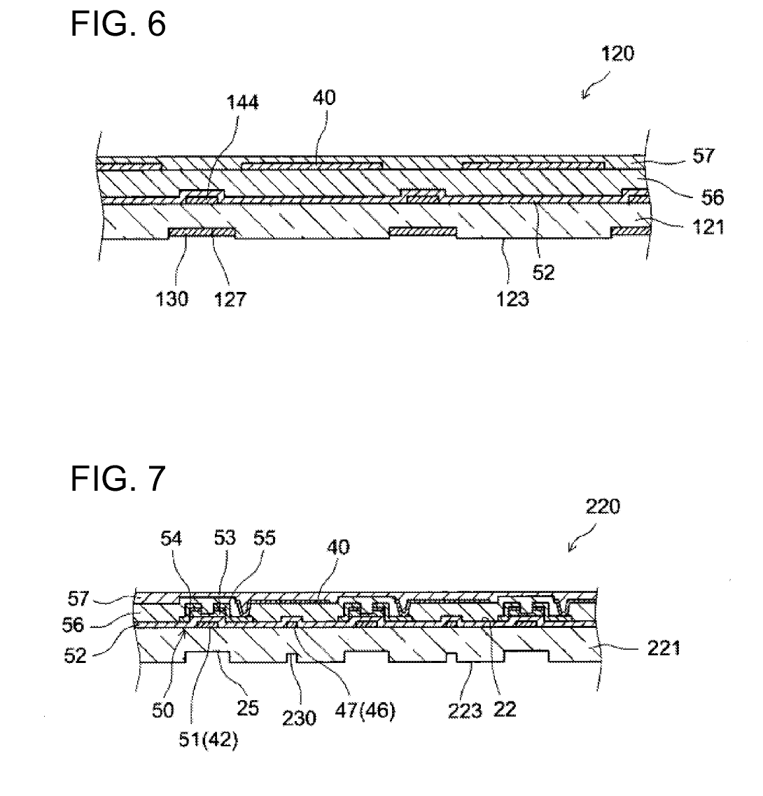

Next, with reference to FIG. 6, Embodiment 2 will be explained. FIG. 6 is a cross-sectional view that schematically shows a structure of an array substrate 120 of the present embodiment.

As shown in FIG. 6, in the panel surface 123 on the rear side of a main array substrate body 121 where source wiring lines 144 are formed, a plurality of concavities 127 that are recessed from a panel surface 123 on the rear side of a main array substrate body 121 are formed below the source wiring lines 144. A resin material 130 including an anti-static substance fills the concavities 127 so as to be slightly recessed from the panel surface 123 on the rear side of the main array substrate body (such that the surface of the rear side panel surface 123 is not flush with the surface of the resin material including the anti-static substance filled into the concavities 127). There is no limit on the anti-static substance of the present embodiment, and an anion anti-static substance made of an alkyl sulfate or the like, a cation anti-static substance made of a quaternary ammonium salt or the like, a nonion anti-static substance made of an ethanol amide or the like, a polymer anti-static substance made of a polyacrylic acid or the like, a conductive metal powder, carbon nanotubes, and the like can be used, for example. Also, there is no limit on the resin material 130 as long as it is a transparent resin material, and examples include a polyester resin, an acrylic resin, a urethane resin, and like.

The array substrate 120 of this configuration has effects similar to Embodiment 1, and in addition, an anti-static substance is included in the array substrate 120, thus improving the anti-static property.

The concavities may be formed regularly (continuously or intermittently, for example) below the gate wiring lines and the gate electrodes, in the panel surface 123 on the rear side of the main array substrate body 121. Also, the resin material 130 including an anti-static substance may be filled into the concavities 127 such that the rear side panel surface 123 becomes flush with the resin material 130 filled into the concavities 127.

Next, with reference to FIG. 7, Embodiment 3 will be explained. FIG. 7 is a cross-sectional view that schematically shows a structure of an array substrate 220 of the present embodiment.

As shown in FIG. 7, in the array substrate 220 of the present embodiment, a plurality of concavities 230 recessed from a panel surface 223 on the rear of a main array substrate body 221 are formed regularly below auxiliary capacitance electrodes 47 (auxiliary capacitance wiring lines 46) in the panel surface 223 on the rear side of the main array substrate 221 on which TFTs 50 are formed. As a result, the roughness of the panel surface 223 on the rear side of the main array substrate body 21 is further increased. Because the concavities 230 are formed below the auxiliary capacitance electrodes 47 (auxiliary capacitance electrodes 46), it is possible to mitigate the occurrence of defects (display unevenness and the like, for example) in image display occurring due to changes in optical characteristics that could occur due to the formation of the concavities 230.

Specific examples of the present invention were described above in detail with reference to the figures, but these specific examples are illustrative, and not limiting the scope of the claims. The technical scope defined by the claims includes various modifications of the specific examples described above.

The main array substrate body is not limited to being made of glass, and may be made of another material (synthetic resins and the like), for example.

### INDUSTRIAL APPLICABILITY

According to the present invention, a plurality of concavities are formed in the rear surface of the array substrate, and thus, it is possible to prevent peeling electrification from occurring when the array substrate is transferred from a stage in the manufacturing steps for the liquid crystal display panel.

### Description of Reference Characters

10 liquid crystal display panel
10A display region
12 liquid crystal layer
20 array substrate
21 main array substrate body
22 front panel surface
23 rear panel surface
25 concavity
27 concavity
29 polarizing plate
30 color filter substrate (CF substrate)
31 main color filter substrate body
32 front panel surface
33 black matrix
34 color filter
36 insulating film
37 opposite electrode
38 alignment film
39 polarizing plate
40 pixel electrode
41 contact hole
42 gate wiring line (wiring line)
44 source wiring line (wiring line)
46 auxiliary capacitance wiring line (wiring line)
47 auxiliary capacitance electrode
50 thin film transistor (TFT)
51 gate electrode (wiring line)
52 gate insulating film (insulating layer)
53 semiconductor film (semiconductor layer)
54 source electrode (wiring line)
55 drain electrode
56 interlayer insulating film (interlayer insulating layer)
57 alignment film
70,72 resist film
80 backlight device
82 point light source
84 wiring line substrate
86 light guide plate
87 optical sheets
88 chassis
89 reflective sheet
90 bezel
92 frame
95 external driver circuit
100 liquid crystal display device
120 array substrate
121 main array substrate body
123 rear panel surface
127 concavity
130 resin material
144 source wiring line
220 array substrate
221 main array substrate body
223 rear panel surface
230 concavity

1. An array substrate included in a liquid crystal display panel, comprising:
a main array substrate body; and
wiring lines including thin film transistors disposed on one panel surface of the main array substrate body,
wherein, in the main array substrate body, a surface thereof has a plurality of concavities that are recessed from the surface of the main array substrate body, said surface being on a side opposite to the panel surface where the wiring lines are disposed.

2. The array substrate for a liquid crystal display panel according to claim 1, wherein the plurality of concavities are disposed in positions corresponding to the thin film transistors.

3. The array substrate for a liquid crystal display panel according to claim 1,
wherein the wiring lines include a plurality of gate wiring lines and a plurality of source wiring lines intersecting with the gate wiring lines, and
wherein the plurality of concavities are disposed regularly along the gate wiring lines and the source wiring lines, in positions corresponding to the gate wiring lines and the source wiring lines.

4. The array substrate for a liquid crystal display panel according to claim 1, wherein the plurality of concavities are filled with an anti-static substance.

5. A liquid crystal display panel, comprising the array substrate for a liquid crystal display panel according to claim 1.

6. A liquid crystal display device, comprising the liquid crystal display panel according to claim 5.
